(19) United States
(12) Patent Application Publication
(10) Pub. No.: US 2024/0241858 A1
(43) Pub. Date: Jul. 18, 2024

(54) Method and System for Processing File Metadata

(71) Applicant: Vigilant AI, Kanata (CA)

(72) Inventors: Daniel G. Willis, Smith Falls (CA); Helge Bruggemann, Vernon (CA); Mark Hedley, Dorset (CA); John Craig, Kanata (CA); Ronnie Jensen, Kamloops (CA)

(21) Appl. No.: 18/409,770

(22) Filed: Jan. 10, 2024

Related U.S. Application Data
(60) Provisional application No. 63/479,674, filed on Jan. 12, 2023.

(51) Int. Cl. G06F 16/16; G06F 16/29; G06F 21/62

(52) U.S. Cl. CPC G06F 16/164; G06F 16/29; G06F 21/6218

(57) ABSTRACT

A method and system provides a data store comprising first data elements therein. The system has a first processing system having access to the data store and a first metadata store comprising first metadata elements therein relating to the first data elements. The system also has second metadata comprising additional metadata for use in generating one or more predictive models, the second metadata including data derived from at least some of the first metadata and the first data elements. The system generates a predictive model based on at least the second metadata.

### FIELD OF THE INVENTION

The invention relates generally to metadata and more specifically to a method of storing and processing metadata.

### BACKGROUND

In document management, abstracts are generated by authors to make searching and retrieving of documents easier. The abstract allows an author to highlight the most important aspects of a paper for easy access and quick review by other researchers. The abstract, when well-written, provides an overview of the document contents and purpose. It makes filtering of returned documents easier while reducing the amount of information that must be evaluated.

In file management, metadata is replied upon for searching. This makes sense because early computer systems were not likely to review document content or to comprehend document contents. Thus, metadata typically included the last time a file was accessed and when the file was created.

With the advent of the Internet, search tools sought more detailed metadata. This has resulted in a metadata field allowing a document creator to specify all search terms relating to a document. For example, a page about a film may include in its metadata a film category, notable actors, awards, etc. Though these may not be visible on each page, their inclusion helps when searching for web site documents—pages. A huge advantage to this model is that page creators can use metadata to relate their pages to related but different information. For example, a page relating to an SUV (sport utility vehicle) might want to be indexed based on all similar SUVs so that searching for any SUV might bring up the page. This use of metadata allows for pages to better be found, even when you are not certain what you are looking for. It is also helpful in directing users to competitive offerings and third-party parts and services.

Unfortunately, with user created metadata comes the opportunity for abuse. Thus, pure metadata-based searching turns up a lot of unrelated material because the page creators want to appear even when they are not particularly relevant. Thus, metadata alone has become a difficult data source for search and filtering.

It would be advantageous to improve the usefulness and effectiveness of at least some metadata.

### SUMMARY OF EMBODIMENTS

In accordance with embodiments of the invention there is provided a method comprising: accessing a data element within a data store; determining for the data access a value for each of a plurality of metadata elements, the plurality of metadata elements having previously determined values stored in association with the data element; and storing the values for each of the plurality of metadata elements as metadata, in conjunction with the previously determined values stored in association with the data element.

In accordance with embodiments of the invention there is provided a method comprising: accessing a data element within a data store; determining for the data access a value for each of a plurality of data, the plurality of metadata elements having previously determined values stored in association with the data element, the determined value based on the data access and at least a previously determined value of the previously determined values; and storing the values for each of the plurality of metadata elements as metadata.

In some embodiments the metadata for being stored is determined based on previously determined metadata and wherein data relating to different metadata elements is stored at different times.

In some embodiments the metadata for being stored relates to same fixed metadata elements, data relating to each metadata element stored with each data element access forming a plurality of metadata instances for a same data element, each instance relating to a different data element access.

In accordance with embodiments of the invention there is provided a method comprising: storing metadata; accessing a data element within a data store, the data element having metadata stored in association therewith; determining a plurality of data relating to metadata elements relating to the data access; and storing the plurality of data as metadata in addition to the previous metadata associated with the data element.

In accordance with embodiments of the invention there is provided a method comprising: forming a predictive model based solely on metadata relating to one or more files.

In some embodiments the predictive model is based on metadata relating to at least two separate files.

In some embodiments the predictive model is based on metadata relating to at least two separate systems.

In some embodiments the predictive model is based on metadata relating to at least two separate applications.

In some embodiments the predictive model is formed absent accessing the first data.

In accordance with embodiments of the invention there is provided a method comprising: forming a predictive model based on data and metadata indicative of behaviours and activity relating to at least two applications.

In accordance with embodiments of the invention there is provided a method comprising: forming a predictive model based on data and metadata indicative of behaviours and activity relating to two different systems.

In accordance with embodiments of the invention there is provided a method comprising: storing first data within a first data store; storing within the first data store first metadata comprising a plurality of metadata elements in association with the first data; storing within the first data store second metadata comprising a plurality of metadata elements in association with data other than stored within the first data store; and in response to at least one of a data filtering and data search request, accessing the first metadata and the second metadata to process at least part of the at least one of a data filtering and data search request.

In accordance with embodiments of the invention there is provided a method comprising: storing first data within a first data store; storing within the first data store first metadata comprising a plurality of metadata elements in association with the first data; in response to at least one of a data filtering and data search request by a first process, requesting second metadata from a second data store, the second data store other than within control of the first process; receiving a subset of the second metadata from the second data store, the subset less than all of the second metadata and filtered by a second process based on an access privilege of the first process; and accessing the first metadata and the subset of the second metadata to process at least part of the at least one of a data filtering and data search request.

In accordance with embodiments of the invention there is provided a method comprising: storing first data within a first data store; and storing within the first data store first metadata comprising a plurality of metadata elements in association with the first data, some of the metadata elements comprising statistically calculated statistical values derived from one of the first data and the first metadata.

In accordance with embodiments of the invention there is provided a method comprising: storing first data within a first data store; and storing within the first data store first metadata comprising a plurality of metadata elements in association with the first data, some of the metadata elements indicating user behaviour when accessing the first data, the user behaviour comparing at least two separate events in time.

In some embodiments the plurality of metadata elements comprises data relating to file access times for different groups of users.

In some embodiments the plurality of metadata elements comprises data relating to file access times for each of a plurality of different groups of users.

In some embodiments the two separate events relate to a frequency of data access and wherein during a restore operation, files are restored in order of frequency of data access.

In accordance with embodiments of the invention there is provided a method comprising: storing first data within a first data store comprising at least an email file; storing first metadata comprising a plurality of metadata elements in association with the first data; and based upon the first metadata, organising display of the email data, the email data organised differently for different functions based on different portions of the first metadata.

In some embodiments email messages are displayed in an order indicating priority based on the first metadata.

In some embodiments the first metadata incorporates metadata relating to files within a datastore other than email files and attachments.

In some embodiments the email is displayed in threads associated with a transaction.

In accordance with embodiments of the invention there is provided a method comprising: providing a first metadata data set; providing a second other metadata data set; and using a correlation engine correlating the first metadata data set and the second metadata data set to produce a new metadata set incorporating data from each of the first metadata data set and the second other metadata data set.

In some embodiments the first metadata data set relates to first data and the second other metadata data set relates to second other data and where the correlation engine is provided access to the first data and the second other data in performing correlating.

In some embodiments the method comprises: using a correlation engine correlating the first metadata data set and the second metadata data set to produce a second new metadata set incorporating data from each of the first metadata set and the second other metadata data set, the second new metadata data set derived from the same first metadata data set and the same second other metadata data set as the new metadata data set and the second new metadata data set different from the new metadata data set.

In accordance with embodiments of the invention there is provided a method comprising: providing an external process with a metadata view of internal data, the metadata view different from a metadata view of an internal process.

In accordance with embodiments of the invention there is provided a method comprising: providing a spreadsheet including metadata therein within spreadsheet entries, the metadata for analysis and for linking to actual data outside the spreadsheet.

In accordance with embodiments of the invention there is provided a method comprising: storing first data within a first data store; storing within the first data store first metadata comprising a plurality of metadata elements in association with the first data; storing within the first metadata data relating to events, the events for use in at least one of punctuation of metadata analysis and labeling of data based on the events.

In some embodiments the events include executing a contract and completing the contract and wherein in listing documents, documents are grouped as occurring before executing the contract, during the contract, and after the contract is completed.

In some embodiments the first metadata is filterable to create a filtered snapshot of the first metadata, the filtered snapshot allowing analysis of the first data based on the filtered snapshot of the first metadata.

In some embodiments the filtering results in a temporal snapshot of the first metadata.

In accordance with embodiments of the invention there is provided a method comprising: storing first data within a data store; storing first metadata comprising a plurality of metadata elements in association with the first data; storing with the first metadata elements, metadata context data for determining at least one of relevance, transformation and filtering of data associated with the metadata elements; providing a first data view of the first data, the first data view comprising some of the first data being at least one of transformed, filtered, or selected based on the metadata context data; and providing a second data view of the first data, the second data view comprising some of the first data being at least one of transformed, filtered, or selected based on the metadata context data, the second data view different from the first data view.

In accordance with embodiments of the invention there is provided a method comprising: storing first data within a data store; storing first metadata comprising a plurality of metadata elements in association with the first data; predicting, based on the first metadata, a data element t to be included in the first data approximately at a known time; and at the known time, verifying a presence of the predicted data element within the first data to when the data is other than present provide a reminder regarding an absence of the data.

In accordance with embodiments of the invention there is provided a method comprising: storing first data within a data store; storing first metadata comprising a plurality of metadata elements in association with the first data; predicting, based on the first metadata, a trend; and providing an indication of the trend.

In accordance with embodiments of the invention there is provided a method comprising: processing metadata in a recursive fashion wherein some metadata is processed on different systems and wherein metadata passed from one recursion to another differs depending on security and data sharing parameters of each system relative one to another.

In accordance with embodiments of the invention there is provided a method comprising: storing first data within a data store; storing first metadata comprising a plurality of metadata elements in association with the first data; using the first metadata for determining data and metadata segments for use with a first application; and using the first metadata for determining different data and metadata segments for use with a second other application.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified diagram of a computer network according to the prior art.

FIG. 2 is a simplified diagram of a file system metadata approach according to the prior art.

FIG. 2.5 is a simplified diagram of a file system metadata approach according to the prior art wherein the updated metadata overwrites the existing metadata.

FIG. 3.0 is a simplified diagram of a file header metadata approach according to the prior art.

FIG. 4a is a simplified data diagram for a method of collecting time varying metadata.

FIG. 4b is a simplified flow diagram of a method of collecting time varying metadata.

FIG. 5a is a simplified data diagram for a method of collecting time varying metadata for searching.

FIG. 5b is a simplified flow diagram of a method of using time varying metadata in searching relying on memories of times a file was accessed, what was done to the file, and by whom. The method is further improved when file content information is also recalled.

FIG. 6 is a simplified flow diagram of a method of using time varying metadata in another application relating to searching and retrieving file data for a recently modified file. FIG. 6a is a data diagram for the simplified flow diagram of FIG. 6b.

FIG. 7 is a simplified flow diagram of a method of using time varying metadata in another way relating to searching and retrieving file data.

FIG. 8 is a data management system with different metadata fields associated with different records and times allowing for same cloud data to have different metadata views, thereof.

FIG. 9 is a data management system with different metadata associated with each person allowing for same cloud data to have different metadata views, thereof.

FIG. 10 is a system collecting metadata associated with an individual.

FIG. 11 is a system for collecting metadata and for calculating further metadata.

FIG. 12 is a simplified method of extracting supradata.

FIG. 13 is supradata data store or repository, comprising a supradata set for each of a multiplicity of organizations, each with their own view of the supradata repository.

FIG. 14 is a supradata repository for a multiplicity of applications each with their own view.

FIG. 15 is a supradata data set with historical records delineated and punctuated not by time, rather by meaningful events, in this case business driven.

FIG. 16 is a method for a multiplicity of supradata data sets, each from a multiplicity of sources being exported and amalgamated but with supradata elements filtered or redacted before delivery to amalgamation.

FIG. 17 is a data diagram for a method for supradata analysis combining supradata from a multiplicity of sources resulting in yet another supradata data set with a deeper more contextual value than the independent originals.

FIG. 18 is a supradata data set with fixed/known fields resulting in structured or semi-structured data, allowing external applications to interact with the data in known, tabular form.

FIG. 19 is a simplified diagram of a method and data for using a supradata data set for predictive modeling and pattern analysis, based on supradata long after the original data is gone.

FIG. 20 is a diagram for a file containing multiple data elements, which in turn contain multiple data elements, which may contain further data elements.

FIG. 21 is a method for storing and maintaining supradata on alternative means of corporate communications.

### DETAILED DESCRIPTION

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Metadata: Metadata is data stored associated with a file or data element but not forming part of the data element content. Common forms of metadata include filename, file type, date of creation and date of last modification. Within a data file system, metadata is stored for each file, often within a table of entries comprising file names, and locations. Some metadata is stored within a file, for example in the file header or in its own portion. Other metadata is stored within a file system in association with a file. Typically, metadata is not displayed when displaying file content as intended; metadata is sometimes displayed in association with file system content.

Supradata: supradata is a combination of metadata, context, actions, transformations, and relationship elements that are stored in a time varying fashion such that metadata is appended to previous metadata instead of overwriting same to form a present, historical, and continuously deepening metadata data set. In addition, supradata includes context regarding the data element. The context may give reference to the origins of the data, the purpose of the data, or the contents of the data. Context also includes actions on, interactions with, and relationships with other data elements within a data set. By example, a PDF contract file may include a link to the email to which it was attached, which in turn contains a link to the email archive from which the email was extracted all within the current or some other external data set.

File update data: file update data comprises data relating to changes to a file content.

File access data: file access data comprises data relating to a file access within a file storage system.

File title data: file title data comprises data relating to one or more file identifiers such as file name, file number, and file identifier.

File version data: file version data comprises data relating to a file with ongoing changes made to the file and to which version of the changing file in order to distinguish one version from another; often file version data comprises a version number.

Data elements: are meaningful segments of information logically identifiable but not necessarily constrained by a one-to-one relationship to a traditional file. For example, an email archive file is a single file which may contain many data elements in the form of emails some of which in turn each may contain additional data elements.

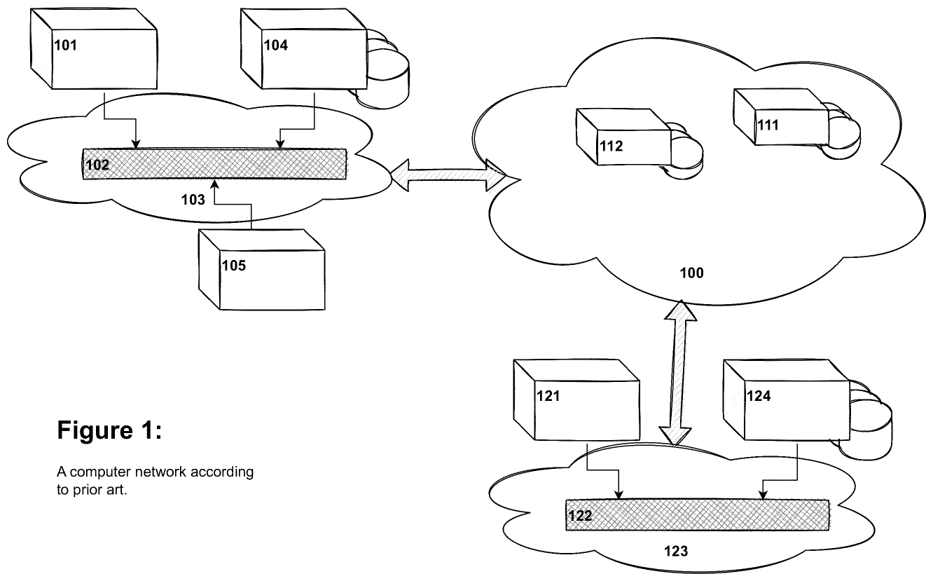

Referring to FIG. 1, shown is a computer network according to the prior art. A first computer 101 is communicatively coupled to a router 102 for forming a local area network 103. The local area network includes server 104 and second computer 105. Local area network 103 is communicatively coupled to Internet 100. Also communicatively coupled to Internet 100 is cloud server 111, server 112, LAN 123 including router 122, computer 121 and server 124. In use computer 101 communicates with server 104 via the local area network 103 and with cloud server 111 via the local area network 103 and the Internet 100.

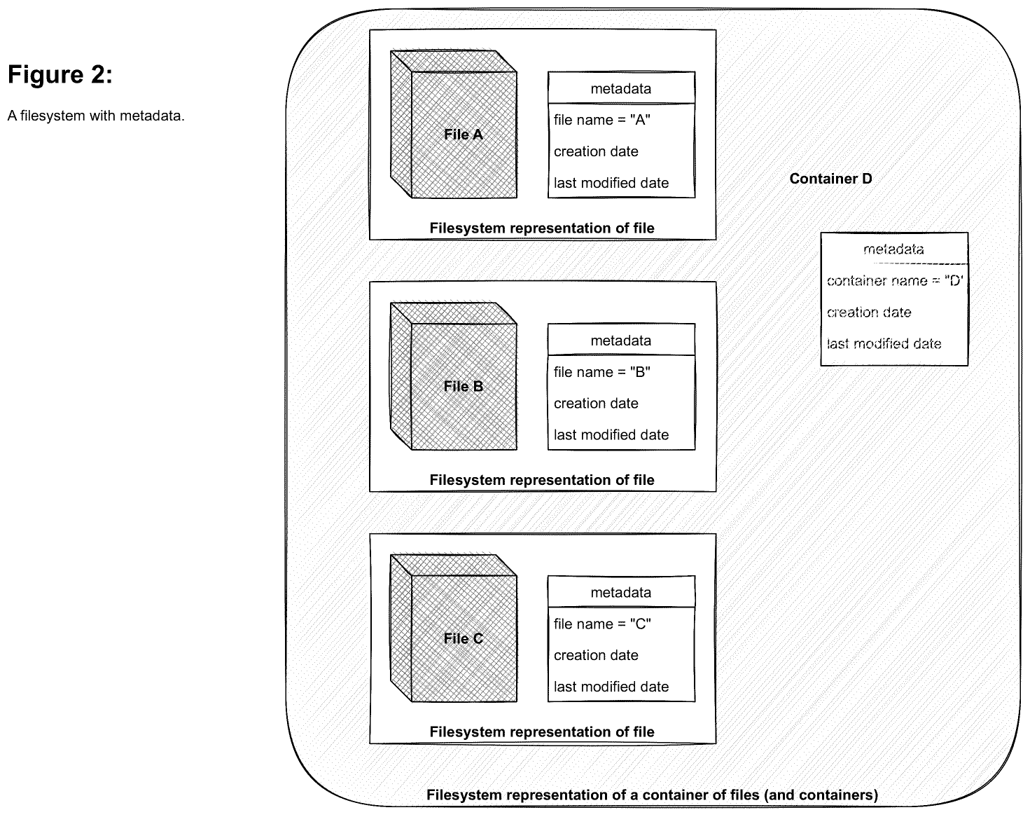

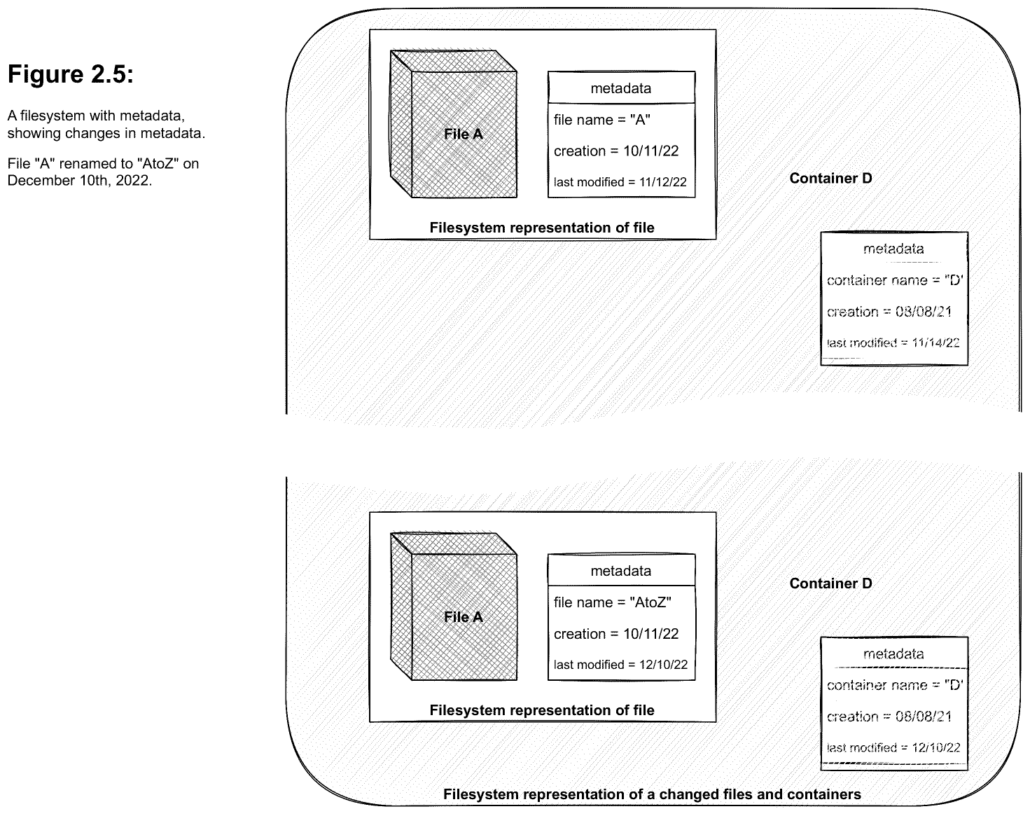

Referring to FIGS. 2 and 2.5, shown is a file system metadata approach according to the prior art. Here, for each file a list of information values is stored including file name, file creation date, file last modified date, etc. As illustrated in FIG. 2.5, each time a given file or container is modified, the modified date is updated to reflect the last time the file was modified. Each time the file name is changed, the previous value is overwritten. Thus, at any time the metadata shows a set of values reflective of the originating information and recent changes of the file.

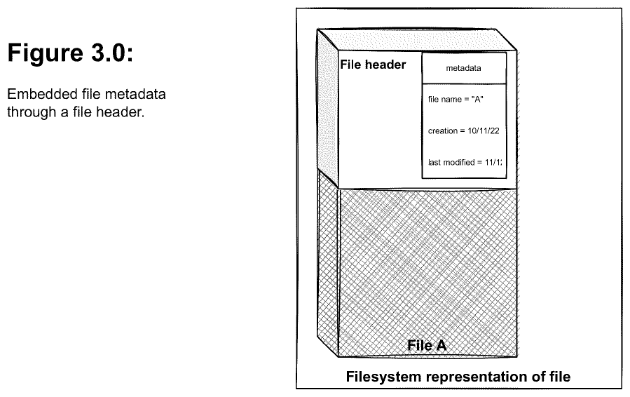

Referring to FIG. 3, shown is a file header metadata approach according to the prior art. Here, a programmer or a user enters information at the header of a file to make searching and accessing the file more convenient. A photograph might have metadata added thereto by the photographer indicating who is in the photograph and where it is taken. Alternatively, the GPS coordinates where it is taken are automatically stored in the photographs metadata. Typically, other file metadata such as ‘date created’ and ‘file name’ are also associated with each photograph. It should be noted that while FIG. 3 depicts the file header metadata as residing at a logical top or beginning of the file. This representation is examplary. The digital location of this file “header” is implementation specific. File headers could be embedded geographically anywhere within the file, at the front, at the end, embedded somewhere within the original data, or may be stored in system records, external files, etc. Typically, file headers are within the data file, itself or stored concatenated therewith.

By creating metadata in this fashion, photo data sets are more easily searched and retrieved. If each picture with a mother and child is tagged with the phrase “mother and child,” then searching mother and child returns all those photographs. Otherwise, searching mother and child will not return any photographs as the phrase is not within the images—an image of a mother and child is. Thus, human created metadata is very useful for organisation and retrieval of non-textual information. It is also useful for retrieval of text information where similar headings or groupings exist. For example, “Fingerprint” is used in crime stories, computer security, criminal investigation and in DNA analysis. Thus, if you were relating information relating to computer security and about fingerprint analysis, including computer security and biometrics in the metadata would be helpful if those words or phrases are not in the document itself.

Unfortunately, the same thing that makes human entered metadata so powerful also makes its abuse simple and common place. A web site for a particular product might use metadata relating to competing products. A website seeking to draw traffic might use metadata to fool search engines into listing them when they lack relevance. Human entered metadata is easily manipulated and has given rise to an entire industry, Search Engine Optimization.

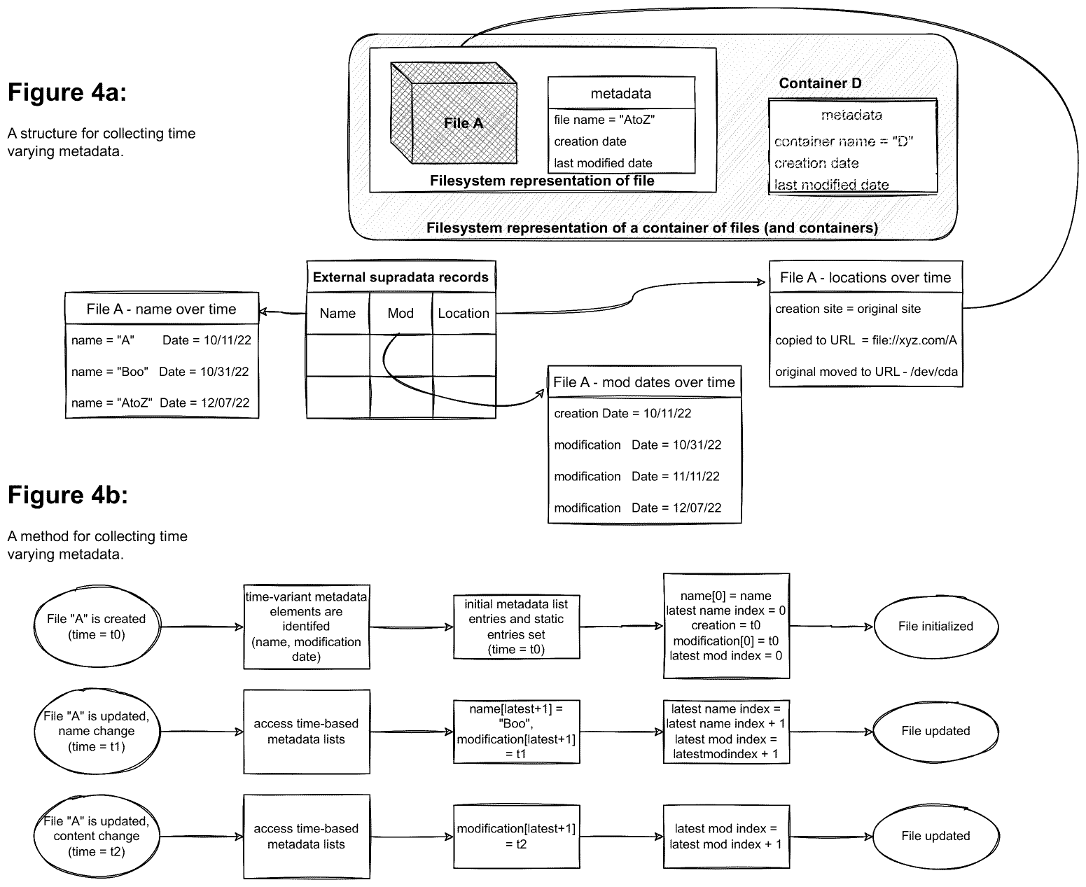

Referring to FIGS. 4a and 4b, shown is a method of collecting time varying metadata. Here, for each file within a file system, a fixed set of metadata is stored. However, each metadata is stored in a time varying form allowing some fields, such as “date modified” to include a list of dates on which the file has been modified. Thus, the file metadata would be able to indicate how often a file is modified—a percentage of days on which it is modified. Similarly, data accessed would also form a list of dates allowing for an estimation of how often the file is accessed.

By selecting metadata categories that are useful when tracked over time and allowing for sufficient granularity in the metadata content, the resulting time varying metadata allows for temporal analysis to determine historical information, usefulness, and active parameters for a file. Further, analysis will also permit the association of files with groups, with each other, and with access/usefulness metrics. Of course, for some applications instead of storing date modified, it would be better to store date and time modified in order to improve the granularity of the metadata. Similarly improved granularity can make other metadata more analytically useful.

Improving metadata to include historical metadata allows for a richer metadata analysis and therefore improves metadata usefulness in file search and access and also in file processing and reliability.

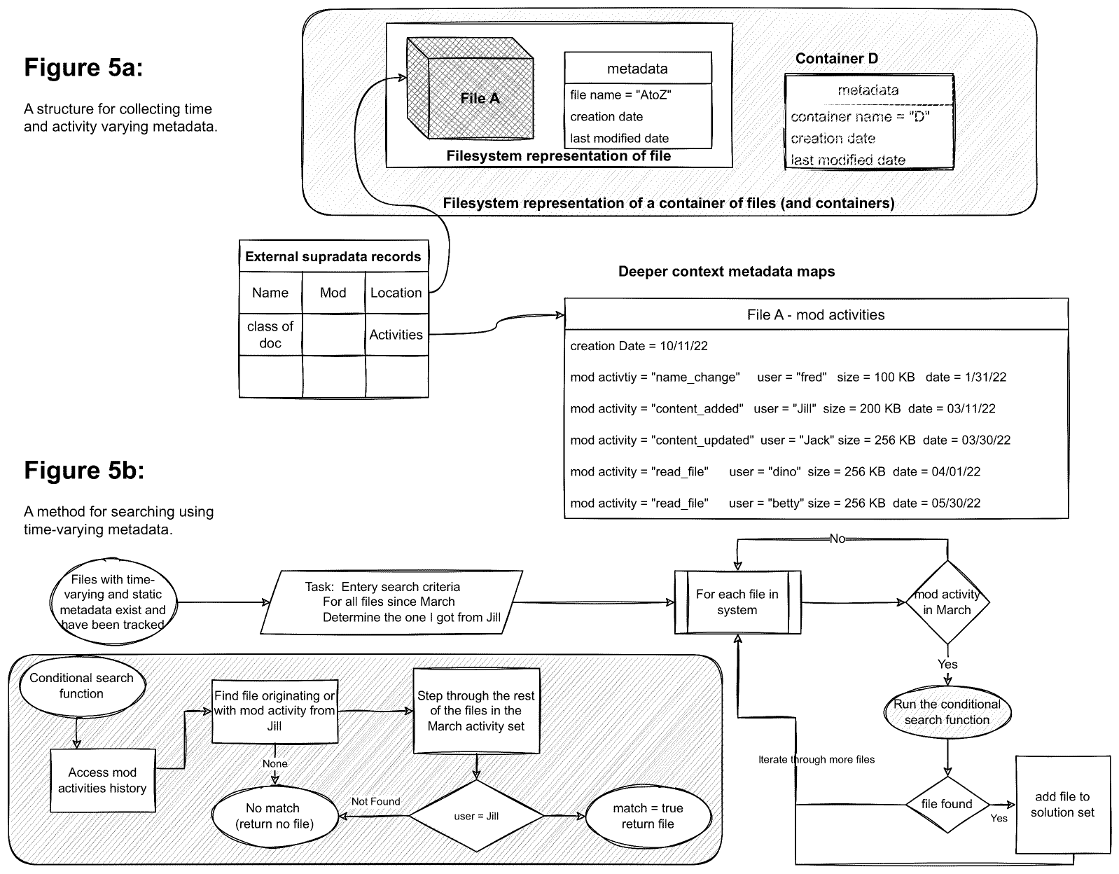

Referring to FIGS. 5a and 5b, shown is a method of using time varying metadata in searching. Here, the metadata includes a list of metadata relating to each access to the file. The list comprises data relating to who accessed the file, when it was accessed, etc.

A user is searching for a file they modified several times in March and that they have barely looked at since. They remember the file dealt with a particular product specification and was sent to them by “Jill.” The user searches for a file that they modified in March and that was received from Jill—for example Jill had accessed the file before the user first accessed the file. Optionally, the user also remembers something about the file content. With the supradata—rich metadata, finding a list of files modified in March is straightforward. Each file modified by the user in March is returned as a set. Finding files accessed by Jill before March is also possible. This is returned as a second set of files. The intersection between these sets should contain the file being sought. If the user also remembers something about the file content, then the resulting list is likely quite small, even for a user who accesses many files each day.

In an embodiment enhancing the previous example, the supradata also has the context that the document was sent in an email by Jill. That reference point could allow for an even more efficient search.

In the above example, the file brings with it, within its associated metadata, information preceding the file being transferred. Of course, this is the case when a link to the file is transferred instead of the actual file or when the file is stored, deduplicated, within a same server. It is often useful to know where the file originated and where it has been after the actual file is transferred and, as such, storing previous metadata with newly transferred files has significant advantages.

Similarly, if five years ago John worked with Jill on a product, John can merely look for all the files where John and Jill modified the same file. By sorting those based on time, it is possible to isolate those files that John and Jill collaborated on five years ago, which will hopefully be a very short list.

In another example, John remembers modifying a file on his 42nd birthday. By searching for files John modified on that specific date, the system returns a list of files to review for the material John is seeking.

By analysing the types of information people use to retrieve files, the choices for both metadata content and granularity are made to facilitate the task of searching. When artificial intelligence is used for searching and retrieval, metadata related to artificial intelligence analysis is stored as well or instead.

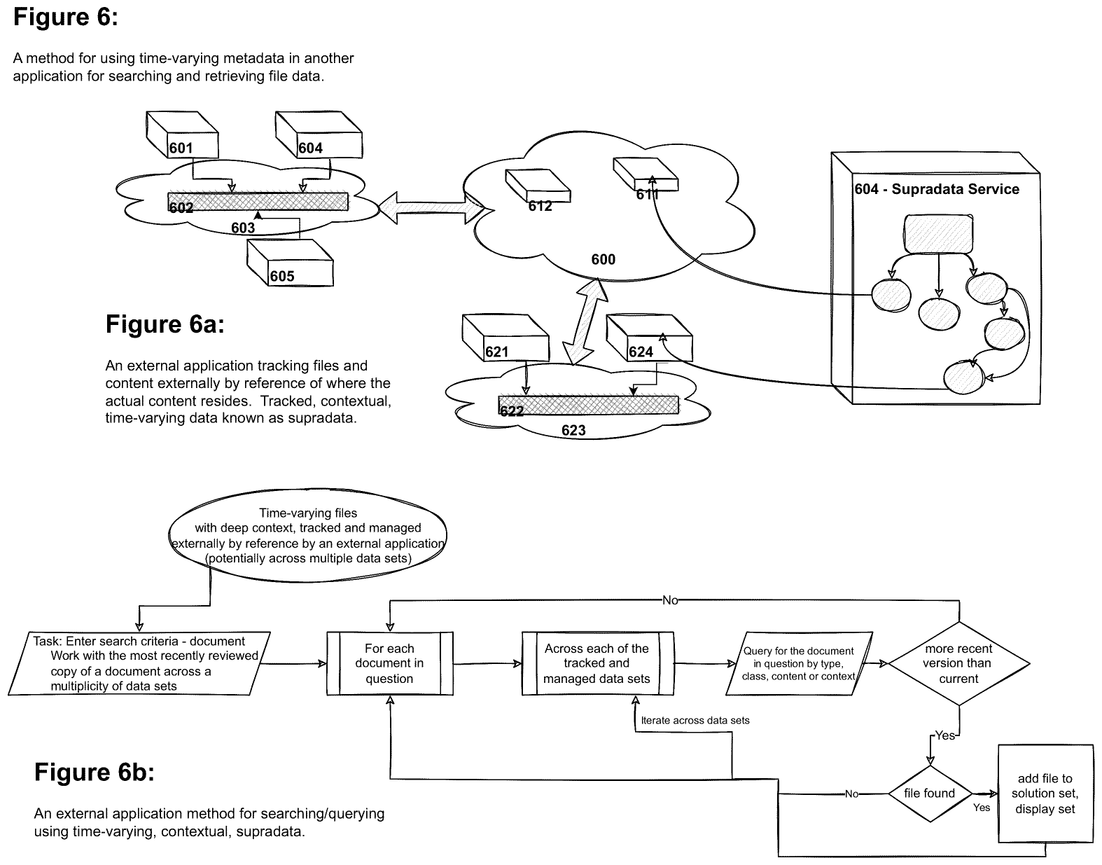

Referring to FIG. 6, including 6a and 6b, shown is a method of using time varying metadata in another application. Here, John is looking to retrieve the most recently reviewed contract draft. He searches for the document with the latest (most recent) date that was accessed by the representative attorneys. Thus, the most recently modified document on his server will not be the result and instead a previous version accessed by the attorneys is returned to work from. This allows John to keep straight the difference between the version he is producing with his client vs. the version he is producing with the parties. This is even more significant when many parties with many competing interests are involved, for example in a multi-party negotiation where parties contribute and negotiate with each other and with the group as a whole. For example, in a multi-party government grant application and contracts for work required for the government grant application, there is often considerable negotiation regarding what needs to be done and who will perform the work.

A key differentiation from traditional metadata in the present embodiment should be noted here. Typical metadata is associated with differing versions of the same file. Such systems become inconsistent when one or more of the parties involved institutes their own versioning by copying the file and changing the name of the copy of the file to the “next version.” Systems searching based on metadata would not consider this new copy a version of the original file. In the supradata system of the present embodiment, the transformation resulting in the copy or parent/child relationship keeps the association in context, even across platforms. Therefore, even different file versions with differing names, across a multiplicity of storage locations, host systems or clouds will be included in the supradata and actions such as search and indexing benefit from the greater efficiency.

In another version of the search of FIG. 6, the last version accessed by each of the parties involved is returned so that the user can see the last file each person reviewed or accessed; even across platforms.

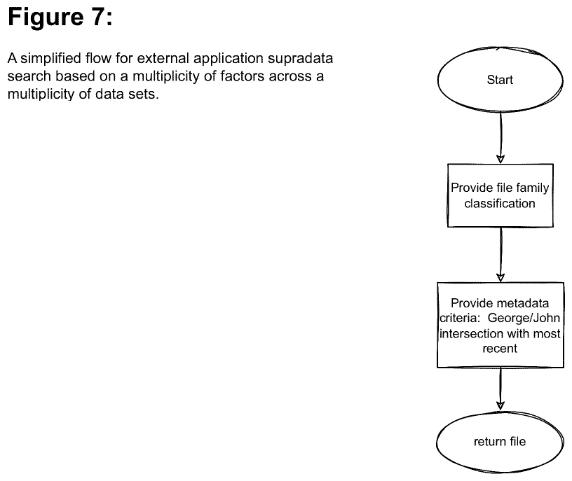

Referring to FIG. 7, shown is a method of using time varying metadata in the above application, differently. Here, John is looking to retrieve the most recent contract draft reviewed by a party in the form of George. John searches for the document with the latest (most recent) date that was accessed by George or his attorneys and that is available to John. This is the latest version shared by John and George. John can see if he sent George the latest version or if it was sent by George to him. Thus, John can use the time varying supradata to track interparty discussions in a complex negotiation. The most recently modified document on John's server may be the result, or instead a previous version accessed by George is returned to work from or for comparison. Further alternatively, a misfiled or unfiled version of the file is returned as the most recent shared version. This allows John to keep different versions without storing each carefully and religiously as received. This also allows John to work with each other party and with his lawyer independently and to merge versions with other parties as progress is made.

The supradata allows each accessible file on each system and within the cloud to be searched and filtered based on a plurality of criteria. The criteria used by John allows for filtering of files to enhance search results and to enhance data retrieval.

It can be noted that supradata differs from change management systems, in that such systems maintain an external journal which logs activity regarding the file and only that file. Whereas supradata maintains the additive historical record of the file, its context, and its origins providing a more meaningful historical footprint which is not constrained solely to the single file in question.

It can be noted that supradata differs from historical journalling and/or time-machine like back up systems, which maintain separate copies of the data as it changes over time. This is both a highly inefficient use of storage resources and still somewhat constrained as it still offers no inter-relationship or contextual information regarding the data element. A restoration of a time-based backup only retrieves an older version of a file, not necessarily the file sent by Jill.

Since supradata spans a multiplicity of platforms, data sources, and potentially timelines, it can build out a context which offers trackability, analysis and insight in a multi-dimensional manner, associating with, but not constrained to, the original data elements. When combined with additional supradata, which may be generated from functional analyses or transformations of some or all of the original data, the supradata presents a multi-dimensional, multi-tier representation of and access to a data set.

Consider the example of a set of student's grades for a core university course which is offered year over year. Tracking across time may be interesting. Now introduce educational background, personal data such as ethnicity, family income, and state of health on each of the students under consideration. Now do this analysis across, multiple years, multiple universities, and perhaps multiple countries and cultures. Add in another factor such as the jobs each of these students took on in the first five years following their graduation, and their success rate and perhaps income over that time frame. The resulting supradata, which could reflect the context and interrelationships of such diversely and disparate source data sets, may well lead to significant insights for academia, for social planning, for urban planning, and perhaps even for the original professor and their teaching techniques. The multi-dimensionality offered by supradata opens a realm of possibility which is neither constrained by the original individual data sources and files nor by their time, location, or who created them.

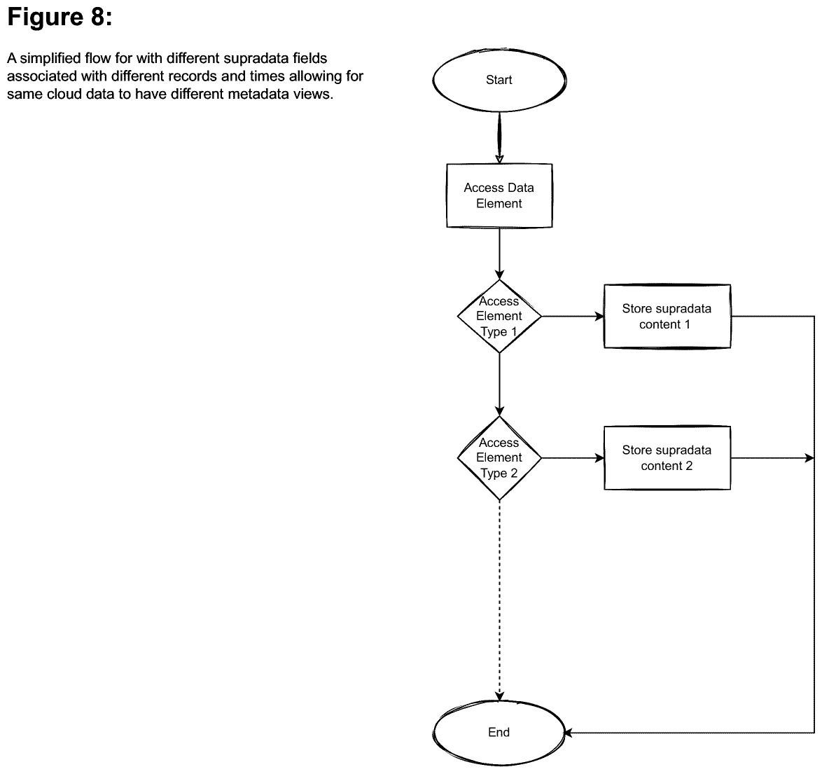

Referring to FIG. 8, shown is a supradata data management system with different metadata fields associated with different records and times allowing for same cloud or even multi-cloud data to have different metadata views, thereof. For example, when data is within a computer system, metadata is created tracking that data locally. This data tracking is different from the data tracking when the data is stored on a server and different still from metadata formed when stored in the cloud. Further, in some embodiments the metadata stored is different if a file is accessed and different if the file is modified. When file level encryption is employed, metadata is often different when the file is decrypted. In one embodiment, the metadata records are identical in fields, but the content is only filled in in some instances. In other embodiments, the metadata records are configured in dependence upon events and data storage, access, and transmission. In some embodiments, different metadata is stored differently, for example in different locations or on different computer or network storage systems.

Such a process allows for competing data entries for a same data field, for example, to be disambiguated without being overwritten. A true cloud implementation of a process may allow the process execution on multiple different servers simultaneously. Thus, the metadata associated with a file on one server may be different than on another. This allows for analysis of metadata based on file localisation, access, and demand. Similarly, metadata associated with processes provide similar multidimensional supradata if the data created during use and access is stored identifiable to one process or another and to one location of execution or another. In some embodiments, the supradata is stored with the file data allowing its use and retrieval with the file. In other embodiments, the supradata is stored with the file system data and is retrievable by processes other than the file system. In some embodiments, the supradata is secured and is only accessible to authorised users and applications. In yet a further embodiment, only some of the supradata is secured while further supradata is publicly accessible.

Examples of different dimensions for supradata collection include location from which file access occurs, age of file, access type, user, user organisation, server location, and previous supradata records.

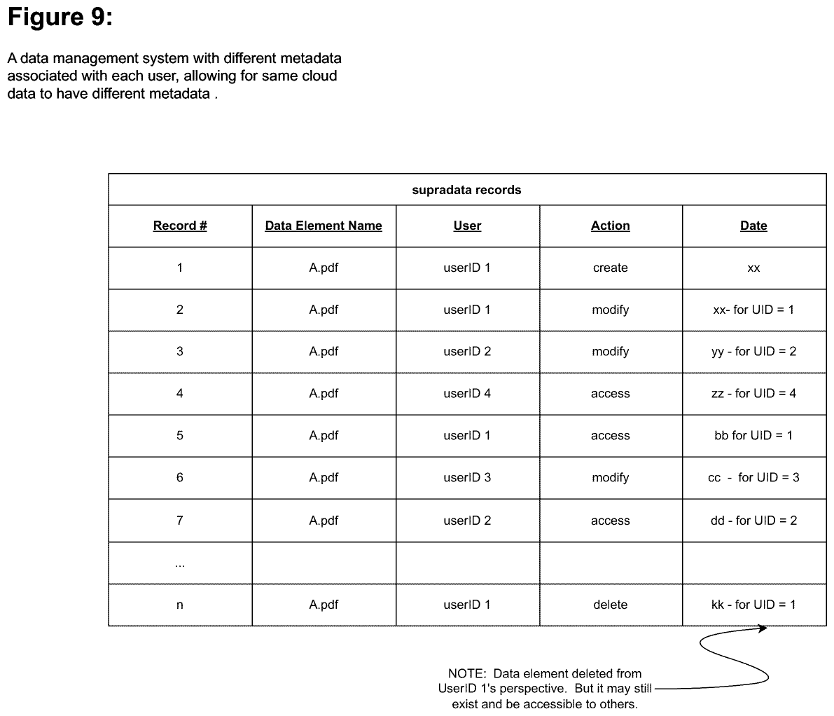

Referring to FIG. 9, shown is a data management system with different metadata associated with each person allowing for same cloud data to have different metadata views, thereof. Here, a file is being shared and edited or commented on by five parties and their representatives. Metadata is stored associated with each user. Even though the file being referenced is the same file, each user has unique metadata referencing it, allowing for differences in access, visibility of the content and portions thereof or editability of the content. This user-unique view of metadata for the content allows for independent tracking with respect to relationships and interactions as well. This is known as multi-view metadata. For example, for each user separate metadata of the last modified date for the file, the last access date for the file, and so forth is stored. A single metadata ‘set’ is formed comprising the metadata for each user, but the metadata ‘set’ can be separated into individual metadata relating to a specific user. This allows users, for example, to search based on their experience with a file or that of a colleague but allows the system to analyse the overall metadata for other purposes. Similarly, metadata relating to other views is also stored so that analysis can be performed based on organisation, profession, function, geography, etc. It should be noted that multi-view metadata (contextualized supradata) allows for differing statuses and states with respect to the same content (file). This also means the very confirmation of existence may have different answers based on the viewer's perspective.

In another example, metadata is stored relating to whether changes are made local to a user's computer, on another computer, via the cloud, or other ways. This metadata is useful to the system for performance optimisation, to the user when they remember making changes while on vacation, to an IT department in relation to file security and duplication—may be a copy was left on the user system, and so forth. The metadata is also useful for use analysis to determine a file storage format and accessibility strategy.

The use of multi-view metadata allows for different metadata sets applicable to different analysis or use. For example, a professor accesses a particular dataset and retrieves particular data. Metadata is stored. A student also accesses the data, and metadata is stored. Since both views are stored, they may be accessed and utilized separately and independently. The university may be more interested in optimising data operations for staff than for students and can therefore view the metadata relating to staff operations independent of other metadata to make optimisations to the overall system. Conversely, the analysis of the metadata relating to student data access may highlight for the professor how the students use the data allowing for improved teaching and education related tools.

With the advancement of AI, large amounts of time varying metadata with a multiplicity of views can be consumed and analysed for multiple purposes. Thus, one or more correlation processors is provided the metadata or a view thereon and operates on the system or on the data in accordance with its training.

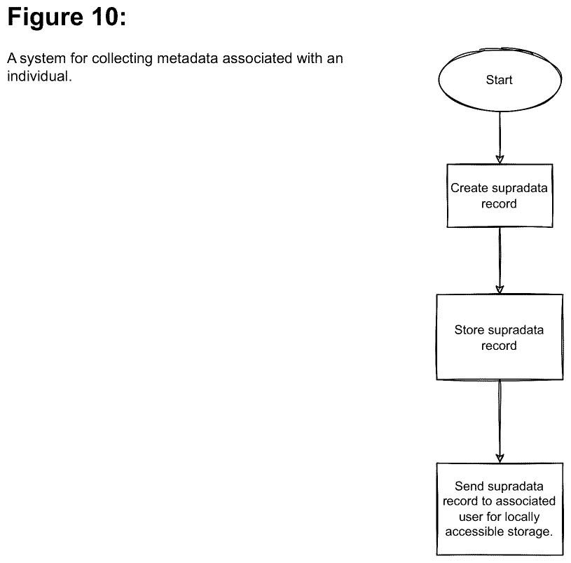

Referring to FIG. 10, shown is a system collecting metadata associated with an individual. Here, the system and the individual intend to use the data for file management and file searching. The system generates metadata whenever an interaction occurs with the file accessed, moved, saved, edited, backed up, copied, etc. The system, with each metadata entry sends the new metadata or an updated metadata set to a first system associated with the individual. The information is stored there for the individual's use. In some embodiments, the two data sets are distinct with the system reserving some metadata for internal use and not sharing same and with the individual doing the same. As this may be multi-view metadata, essentially a contextual view of supradata, there may be multiple such metadata collections for multiple individuals stored in separate records, all associated with one another through supradata and all referencing the same data element(s).

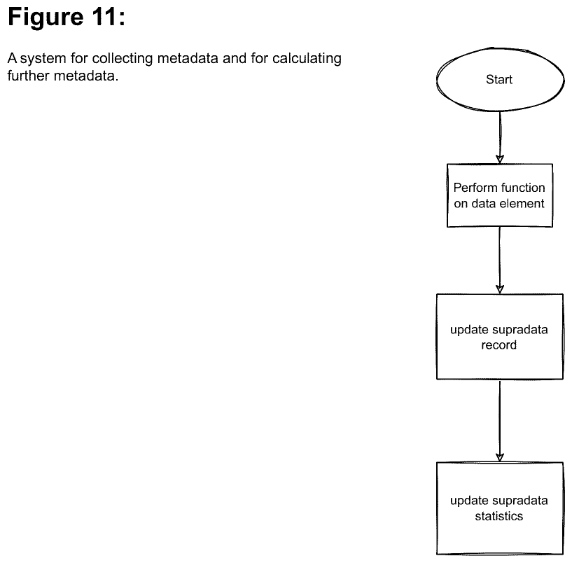

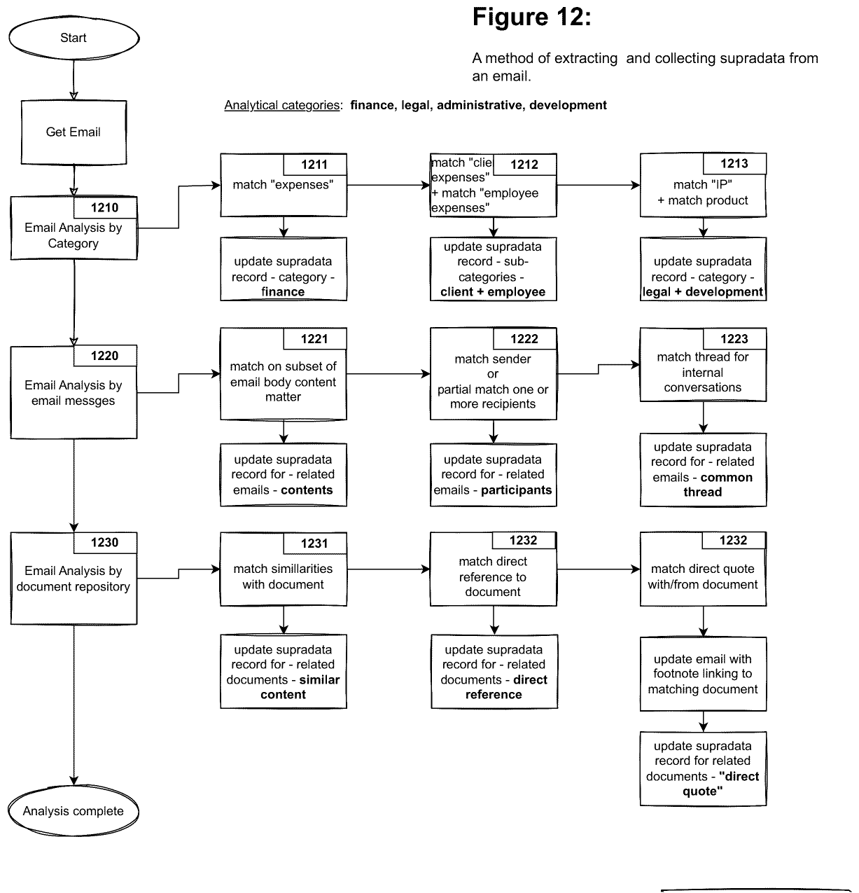

Referring to FIG. 11, shown is a system for collecting metadata and for calculating further metadata. Such metadata delineates activities involving the tracked data element and calculations based on the state, environment, and context of the target content, including supradata and context of other content elements. The result is supradata with updated context. Shown here, an average time between data access events is stored in the metadata. Along with this is the aggregate number of data access events. Thus, multiplying the aggregate number times the average time between data access events, adding the most recent interval and dividing by the aggregate number plus one, gives the new average time. Such a method is applicable to many statistical values that can be calculated and stored in a fashion allowing updated calculation without necessarily storing all the underlying data on which the statistics depend. Similarly, the number of recent intervals in succession that were above or below the average could easily be tracked as shown in the diagram. Here, a recent interval is evaluated as above or below the average. When below the average, the number is decremented if less than 0 and is set to −1 otherwise. When the recent interval is evaluated as above the average, the number is incremented if greater than 0 and otherwise set to 1. Negative numbers indicate a number of below average successive intervals (times negative one) and positive numbers indicate a number of successive above average intervals. The use of successive intervals is useful to indicate a trend—for example data access intervals are longer so the data is less often accessed. The trend is then useful in data management.

Of course, trend analysis is trackable from specific locations when advantageous. For example, how often a file is accessed from remote locations is useful to determine file availability beyond the office. As a file is accessed less often, it need not be stored in always available, higher cost, rapid access cloud storage and instead is stored in the slower or more difficult to reach areas of the network, for example requiring extra steps to access.

Similarly, in the case of catastrophic failure, files that are accessed less frequently are restored later while files that are accessed regularly and often are restored immediately. The metadata so formed includes data relating to file access, data relating to system operation and calculated data forming statistical values relating to file usefulness or use. Further optionally, the metadata includes estimated data relating to expectations of future file access or relating to estimations of present and past file related metadata. Such estimates are particularly useful when they lead to concrete outcomes. For example, when a file is opened and remains open for over 12 hours without modification, the system estimates that the file is open but not in current use. In some embodiments, the system closes the file—stores the present state of the file—and warns the user that the file may have been changed by others while it sat open on the user's desktop. Alternatively, it warns users in the interim that the file is open on the user's desktop allowing them to reach out to the user directly. When the metadata is rich, it will also establish how often this user leaves files open for longer than needed and policies or procedures are optionally designed to address that issue.

The metadata so formed is associated with a file, with an organisation, with a user, with a group of users, etc. As such, policies and procedures are definable to address the issue highlighted by results of analysing the metadata, but also for addressing underlying behaviours when associated with groups whose behaviours are influenceable. For example, when the time a file is left open is stored in association with the specific user, then user's behaviour is addressable through feedback, consequences, or some other mechanism.

The use of data and statistics provides a rich opportunity for improving many aspects of a system. Here, by providing standard fields, statistical data, and bulk data records all within the metadata, the use and flexibility of the metadata is greatly improved. This is achieved without actually opening the content itself. Further, by using different correlation engines with access to the metadata, the system is able to manage in parallel the overall system and the specific system operations. Thus, some or all data is useful for improving system performance while all or other data is useful for performing or improving specific functions.

Relying on correlation engines is beneficial for optimising system performance, but the rich metadata also is beneficial in forensic analysis of performance, results, and system errors or failures.

An email inbox comprises a plurality of email messages. For exemplary purposes, each email message includes the following fields From, To, cc, bcc, Date, Routing, Subject, Body, Attachments. In present email systems, emails are threaded—deemed part of a same thread—when they have a same Subject field. Emails can be sorted by Date or From field. Emails are searchable based on a field or contents within a field.

Now turning to Figure, 12, shown is a simplified flow diagram of a method of extracting Supra-data for use in email analysis, grouping, and retrieval. Here, each email is analysed for extracting further content in order to form a series of associations between the email message and known categories at 1210, between the email message and other email messages at 1220 and between the email message and documents within a document store at 1230. At 1211, a phrase “expenses” within the email message being analysed is associated with a known category—finance—and a record including an identifier of the email message and the category is created. Optionally, each record associates a single email message with a single category. Alternatively, a single record is created associating an email message with a plurality of categories. Differences in implementation allow for, for example, creation of silos of supradata data such that different parts of an organisation access email messages based on different supradata. Within each silo, the email message is associated with “finance” or some equivalent unless said silo is unconcerned with that category. Further analysis at 1212, subcategorises the email message as a client expense and an employee reimbursable expense. At 1213, analysis of the email message continues until complete allowing the email message to be associated with several different categories and sub-categories resulting in a rich supradata set of extracted categorical information.

At 1221, the email message is analysed for comparison against other email messages. Here, email messages are characterised based on similar content forming threads of email messages in relation to topic, contributors, and timing. At 1222, an email is associated with 3 other emails but as some of the senders and recipients differ, it is not simply inserted as part of a thread, instead taking a place within a threading map. Because a single organisation often has many of the contributors to a single thread, at 1223 the threading map is then assembled for all internal participants to form a more complete mapping of a communication thread in time and “space.”

At 1231, the email message is compared to documents within document storage to look for similarities. For example, at 1232 a document is found that is referenced within an email message such that the email message clearly talks about the document. At 1233, a paragraph within an email message is nearly identical to a paragraph within a document—either the email message quotes the document, or the document paragraph originates from the email message. At 1233, a footnote to the document is inserted within the email message and a record preserving the footnote is formed. In this way, each document associated with an email message is mapped within the supradata allowing navigation from document to email to another email and then to another document.

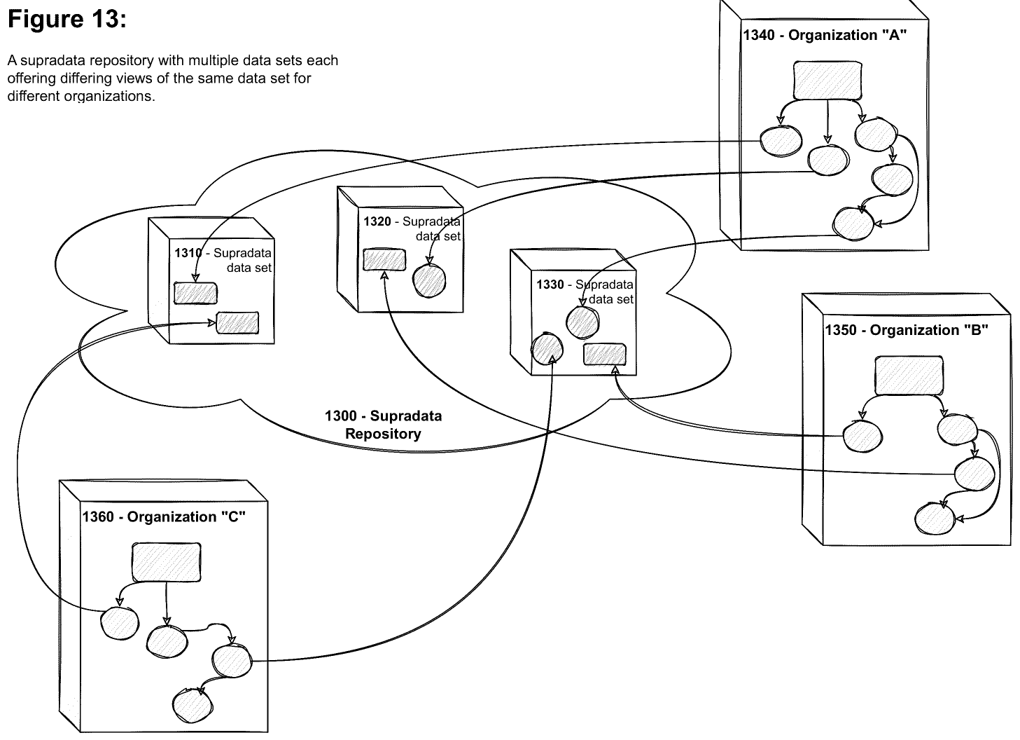

Referring to FIG. 13, shown is a supradata store comprising a supradata set for the marketing organisation at 1310, 1320, and 1330. Each supradata set comprises a different view of the larger data set with some data obfuscated—supradata deleted or omitted—in the final dataset. Separate organizations such as, the finance department at 1340, the R&D department at at 1350, a subsidiary company, and a distributor at 1360 have access to one or more of these views. That said, the distributor has a lot more information within the supradata set about the mapping of email threads than they would by looking at their internal email messages. For example, they can see that a pricing discussion was passed around internally to the main company to the CFO, the VP Marketing, and even to the President of the Company before the distributor received a reply. The company has agreed to share the email mapping data with the distributor in order to ensure that the distributor knows where email threads are “tied up” as they want the distributor to feel “in the loop.”

It should be noted that significant real-world outcomes are achievable by application of analytics that span a multiplicity of supradata data sets whether they exist in a single or multiple repositories. In the example above, the supradata for the distributor and the supradata from marketing and finance which keeps the distributor “in-the-loop” could also have direct implications to logistics, allowing for a distributor to proactively consolidate shipments, targeting them where marketing intends to focus efforts for the quarter. Therefore, with information from a multiplicity of contextually deep data sets with understood data interrelationships supradata results in shorter time-to-market, more highly efficient and optimized shipping and volumes meeting sales and marketing targets; all of which directly impact that organization's bottom line.

Supradata by its associative and ever-deepening contextual properties and by its ability to span a multiplicity of sources and repositories, becomes a highly effective and efficient data platform which accelerates the capabilities of existing solution systems. It offers a novel way to unify data. By breaking down organizational, geographical, and implementational silos, it makes it possible for a simple loosely coupled or singular system to achieve that which would have necessitated a federation of processors and servers with current technologies. Historically, such systems may have been referred to as processing big data. In addition, to unifying data, by the inclusion of contextual actions and operations, it provides for the unified abstracted modelling of complex business processes which may span a multiplicity of document classes, individual documents, and data elements, sourced from a multiplicity of data silos from a diverse set of sources, companies, or organizations. This unification of data, context, and action can result in direct real-world applications.

Without limitation, application of supradata as the underlying repository and infrastructure for solutions, both automated and manual, can be envisaged for a wide range of verticals, including finance and supply chain analytics in enterprises, finance, audit, cost recovery, and consulting analytics in accounting, and applied analytics in artificial intelligence and machine learning.

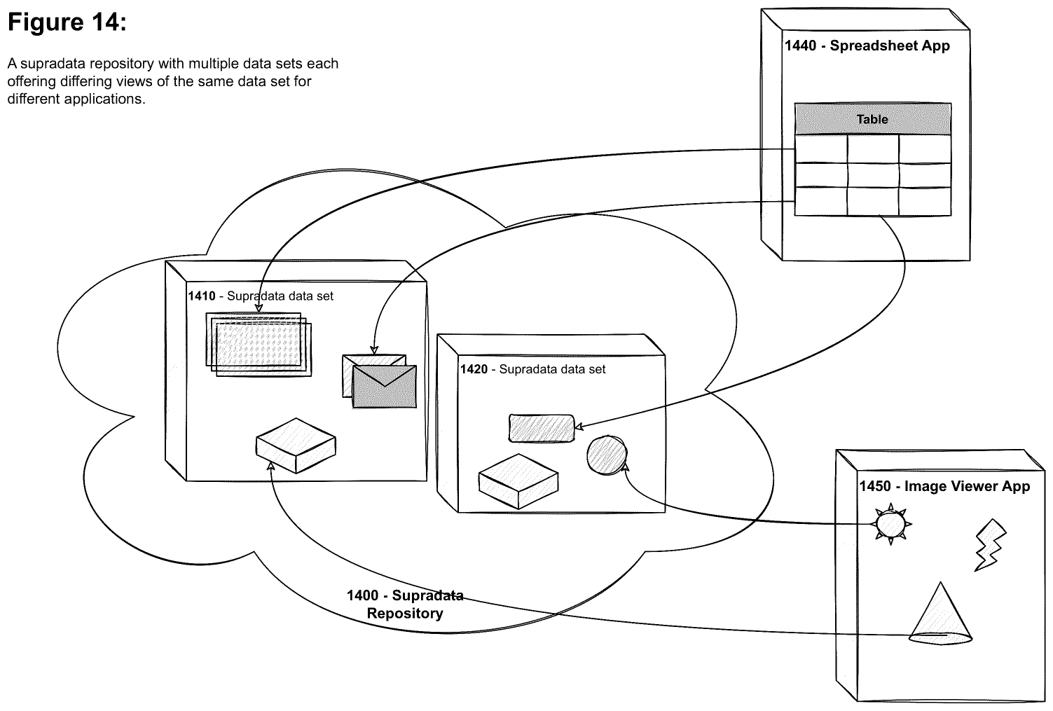

Referring to FIG. 14, instead of supradata being formed for different organisations, supradata sets at 1410 and 1420 are formed for different applications, illustrated at 1440 and 1450. Here, a spreadsheet application at 1440 has a view on email messages and documents that tie into spreadsheet data. This often includes non-spreadsheet documents that are quoted in spreadsheets or that quote spread sheet data. Thus, supradata for use by applications to facilitate workflow is also supported.

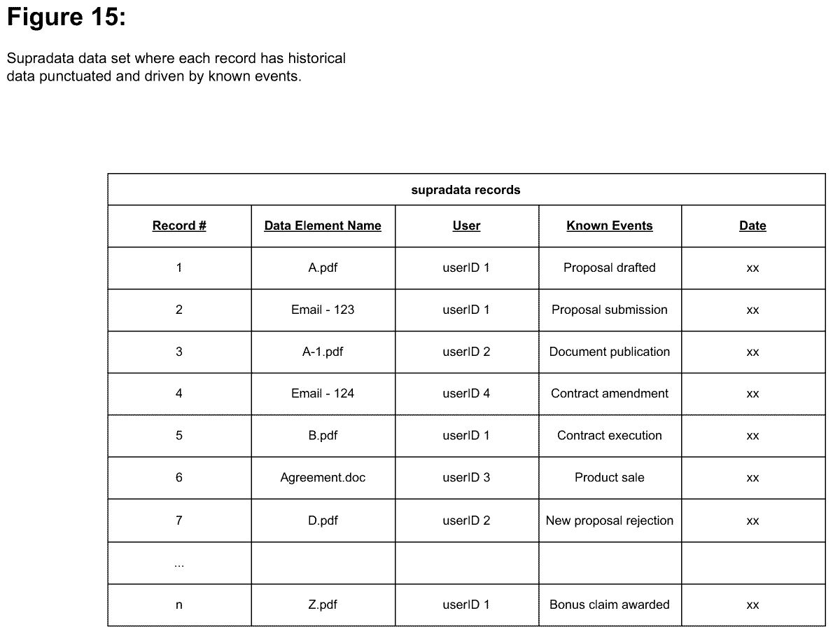

Referring to FIG. 15, shown is a supradata database wherein each record is shown with historical data punctuated by known events. One such event is the passage of time, but in FIG. 15, it is anticipated that business process events or milestones such as document publication, contract execution, product sale, etc. will be punctuating events. Thus, an email and document supradata set relating to the assembly of a marketing plan is formed and when the marketing plan is approved by management, a snapshot of the supradata is made. The supradata is then updated over time as data continues to accrue, but it is possible to search or analyse the data at the time the marketing plan was approved because the snapshot of the supradata is stored. This allows a context to the supradata to be maintained whether generically over time or for specific events. In the example, as the execution of the business plan proceeds, it is a simple query to identify and track the base assumptions and update the living supradata accordingly. In this manner, the supradata offers data driven insights to the process evolving as the context evolves, with necessarily having access the actual content, allowing for more rapid analytics.

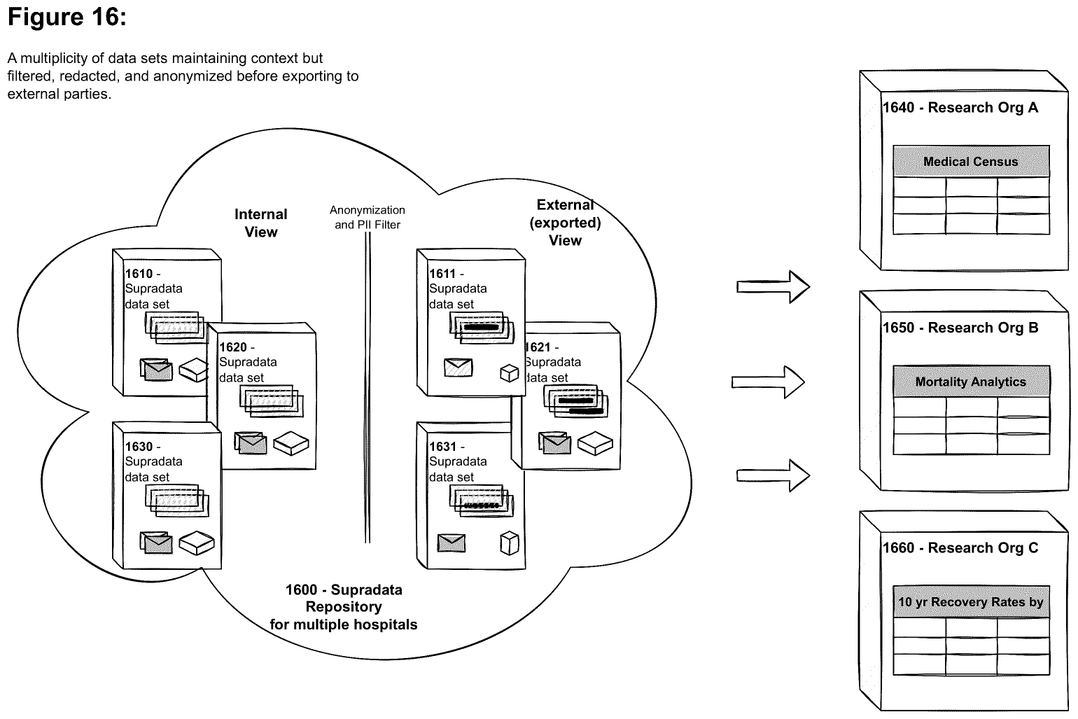

In an embodiment referenced in FIG. 16, a single supradata set includes context data stored therein such that amalgamation of supra data sets illustrated as 1610, 1620, and 1630 at 1600 maintains their context. Context data includes filters on supradata relating to export allowing for context data to also inform a user regarding what might be missing from the data. The context data is indicative of the redactions. With the additional context of the redactions shown respectively at 1611, 1621, and 1631, the value of the insights offered by the exported data is further enhanced while security and data privacy are maintained.

For example, as shown in FIG. 16, a medical database of heart attack patients over the decade following a heart attack is stored for 120 different hospitals. Each hospital forms a supra data dataset including files, charts, procedures, billing, insurance, emails, appointments, cancelations, intervening events, other issues, etc. When exporting the data for amalgamation, each hospital filters out personally identifying information, for example filtered data set 1611 based on 1610, and as such the exported supra data datasets include contextual information—for example hospital size; hospital is urban, suburban, other; transformation of occupation to code category as follows; single, married, divorced; family size range (instead of actual number of children), etc. This contextual information helps researchers know that a hospital of 200-500 beds is an arbitrary category in order to anonymise the data and to then form contextual comparisons with other supra data datasets. Further, in the contextual information, is included other context beneficial data that may not be present in the supradata dataset itself without context. For example, this might include staffing levels for the hospital, funding issues, private/public, etc. Contextual data is significant in many situations where supradata is filtered and even when supradata is provided in its entirety.

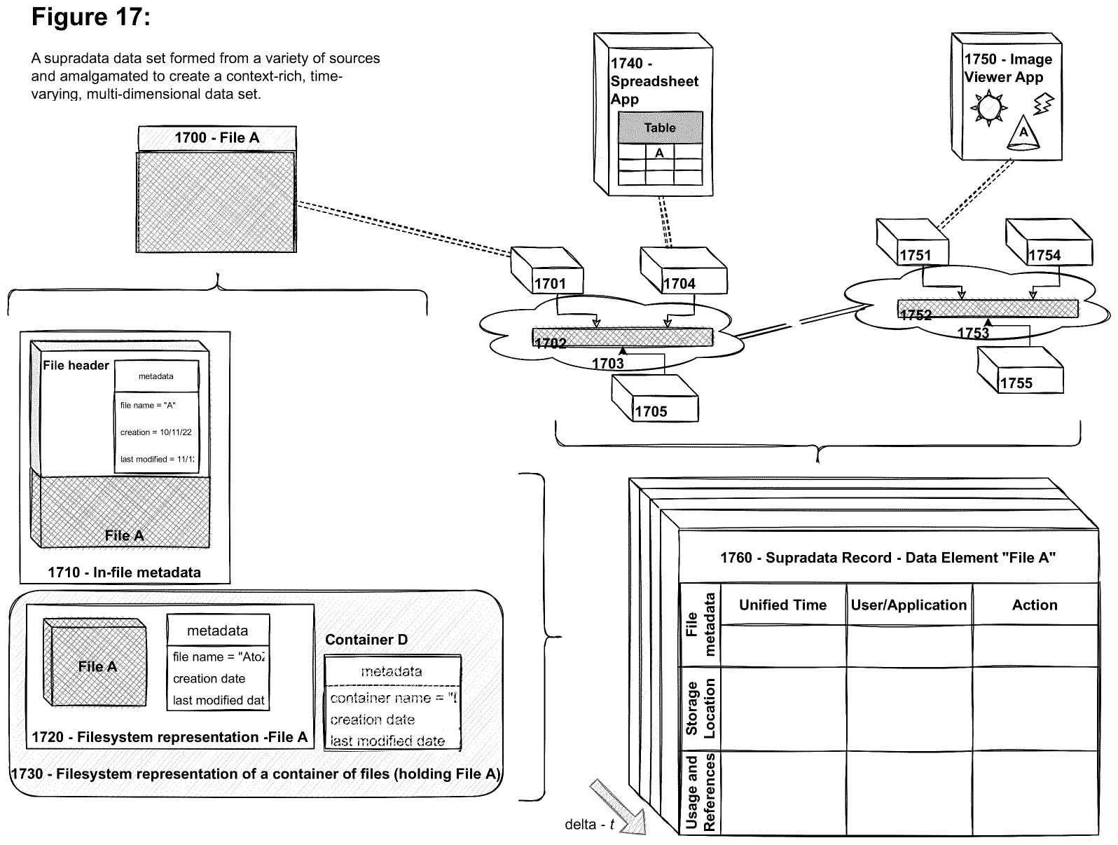

Referring to FIG. 17, here a supradata analysis is provided for metadata. Regarding File A illustrated at 1700. File metadata from an operating system 1720 and 1730 is added to metadata from one or more applications 1740 which is added to metadata from within a file 1710 to form a rich multidimensional supradata dataset. For example, simply by concatenating operating system metadata over time to a supradata dataset, it is possible to determine who accessed each file and when over a period of time. Add to that application metadata 1750, firewall metadata from 1702 and remote network 1752, file level metadata and analysis extracted metadata and a resulting supradata dataset 1760 emerges with significant additional potential and efficiency for analysis and use.

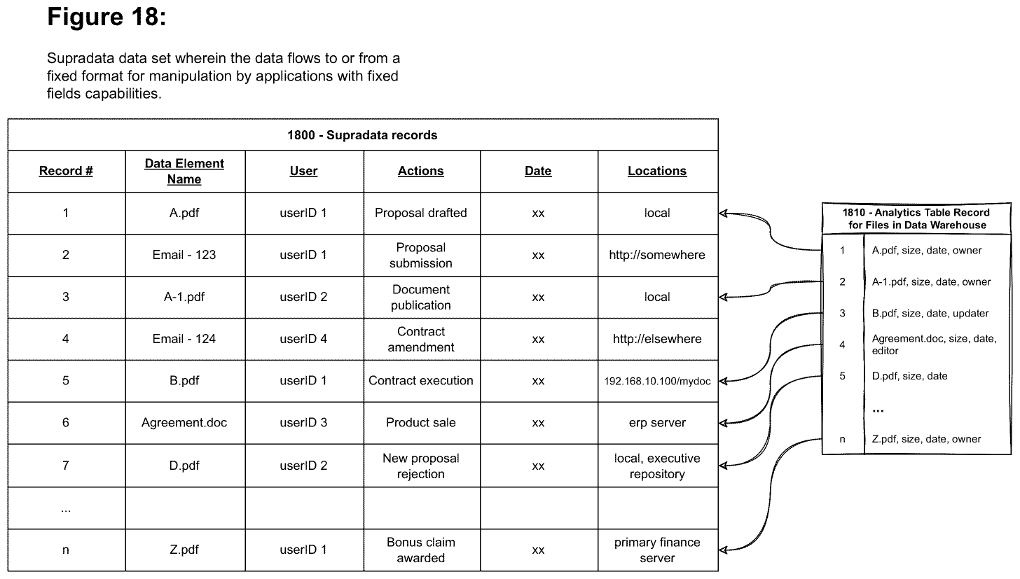

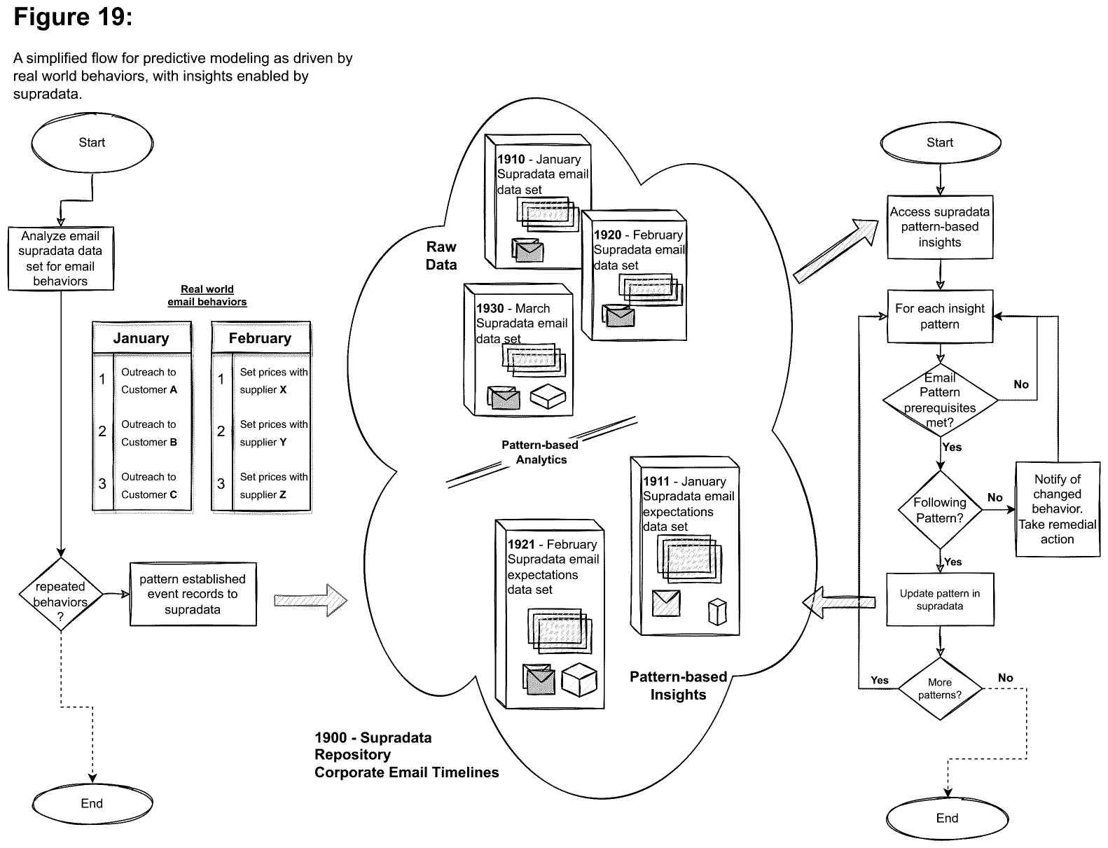

The widely variant content of supradata by its nature cannot always be nicely constrained within a strictly fixed format repository. However, in some embodiments, the implementation of supradata is a hybrid of structured, unstructured, and semi-structured data repositories. Exemplary technologies, without limitation, for such implementations could include relational databases, purpose-built databases, or graph-based databases. Further, with such embodiments, it should be readily achievable for those skilled in the art to map the more flexible, less structured aspects of the supradata onto a structured repository in the form of a view of a subset of the supradata. Referring to FIG. 18, shown is a supradata dataset at 1800 having fixed fields wherein supradata is imported from 1810 and forced into the fixed structure. This allows applications that operate on known supradata forms and contents to operate by stripping supradata and metadata down to the known form or content. When such a dataset stores time relevant data in a historical context, specific metadata fields and their transition over time are evident with the dataset.

Referring to FIG. 19, shown is a predictive model based on supradata. Analysis of email messages within a company extracts certain patterns in the email messaging. For example, the established patterns are learned and retained in supradata that there is always a group of emails with a specific supplier in February and another group of emails with a particular customer in January. However, in the example, for this January no emails are identified to that customer. The pattern in the supradata expected emails to the customer in January and management is notified of the break in the pattern. This break is then addressed by contacting the customer or by accepting that the pattern has changed—ordering patterns are different or they lost the customer. Thus, once patterns are identified in email messages or communications, the future communications are expected to conform to those patterns in a meaningfully predictable way. In this way supradata, provides a foundation for predictive and associative analytics.

In such embodiments, predictive modeling such as customer patterns, employee review patterns, bookkeeping patterns, etc. are all automatically determinable and manageable via supradata data extraction. Whether time frames are extracted objectively—each January—or relatively—within 2 weeks of a first response by a customer we need to reply to that response, automating extraction of supradata and communication patterns allows an organisation to both see what it is doing for human analysis and planning, to enforce what it is doing through alarm conditions, or effectively to predictively improve performance by reminding people when they historically would have done something in advance. For example, a message, “It is January 5^{th} and usually by the 7^{th} you have sent your first email message to customer X about Y,” This is the typical content/structure of that email which Is sent to the appropriate individual on the fifth of January. Of course, the same analysis also informs management of improvements in response times, employees with optimal response times, etc.

Once supradata has analysed several years of performance, some responses and data can be available nearly instantly as it relates to common tasks having common response/performance criteria. Approval of vacation time or personal time might typically happen within 4 hours so the supradata system knows to ping a manager when approval is outside that time. Some communications can be automated or semi-automated by the supradata system such as providing the manager the email to send out to approve, to deny or to ask for more time and allowing the manager to select one to send to the employee. With communications, it is often important to communicate something when expected even if the something is that you have not reached a decision. By performing supradata analysis, it is straightforward to predict an estimated expectation of reply for many interactions. It is also straightforward to plan to improve response times or maintain them in accordance with management goals, employee performance goals, or some other indicator.

The insights developed by supradata analytics, such as predictive models and trends, are themselves data elements which can be associated with the data in the supradata repository. Therefore, they can also be loaded into the repository becoming a tracked data element in a supradata data set. By extension, this also applies to the analysts' interactions with the data. The actual queries and operations carried out on data within the data set become records within the supradata model. These interactions are another form of context and association that is captured and maintained. It can result in real-world actionable insights with significant value to the analysis. For example, a set of queries and interactions with a published quarterly data set for company X becomes part of the supradata. Based on this supradata context for this data set, when the next quarter's data set becomes available, the same series of operations and queries are automatically executed to develop a comparative model between the two quarters in question. Such analyses indicate, for example, to an organization whether things are stable, worsening, or improving over time.

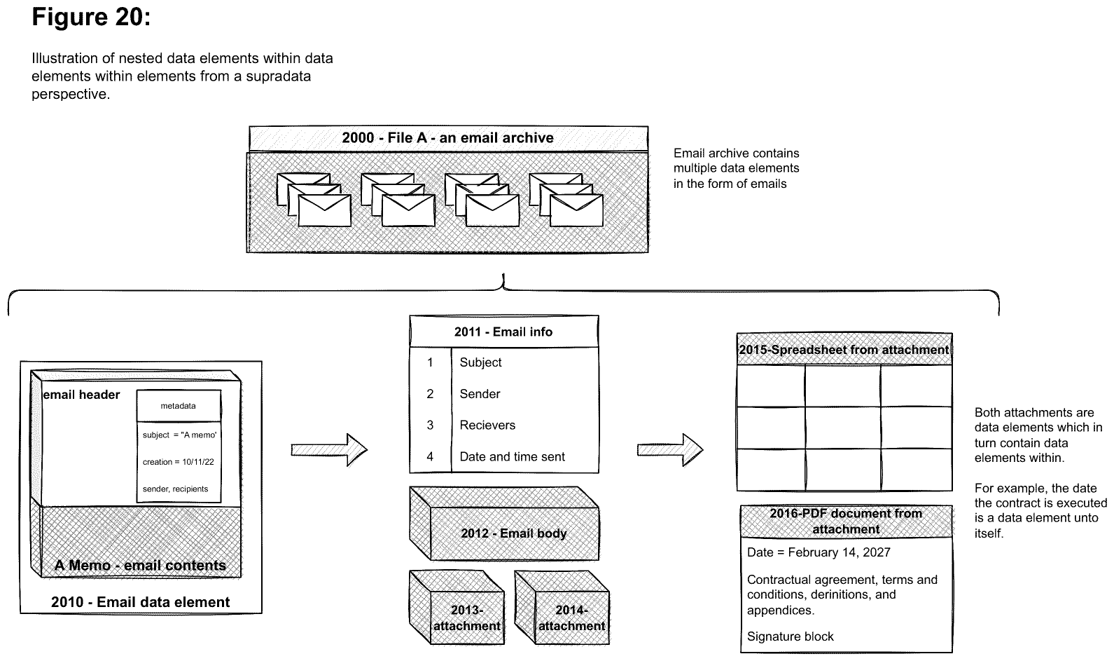

By its associative and contextual nature, supradata is recursive, either containing nested data elements or developing them over time. Referring to FIG. 20, shown is a file containing multiple data elements, which in turn contain multiple data elements, which may contain further data elements.

In an embodiment of supradata, the individual emails contained within an archive each exists as a meaningful segment of information logically separate from the rest, making them each data elements. This also applies to the individual components of each email. The sender/receiver info, the routing information, the body of the email, and any signatures or brand logos are all data segments. Similarly, any attachments to any of those emails each also qualifies as a data segment. This demonstrates a key property of data elements. Data elements are not necessarily atomic. They can contain other data elements. In its simplest form a file can be a data element. However, even a simple file may contain a multiplicity of data elements, for example a PDF file containing a table of observed data.

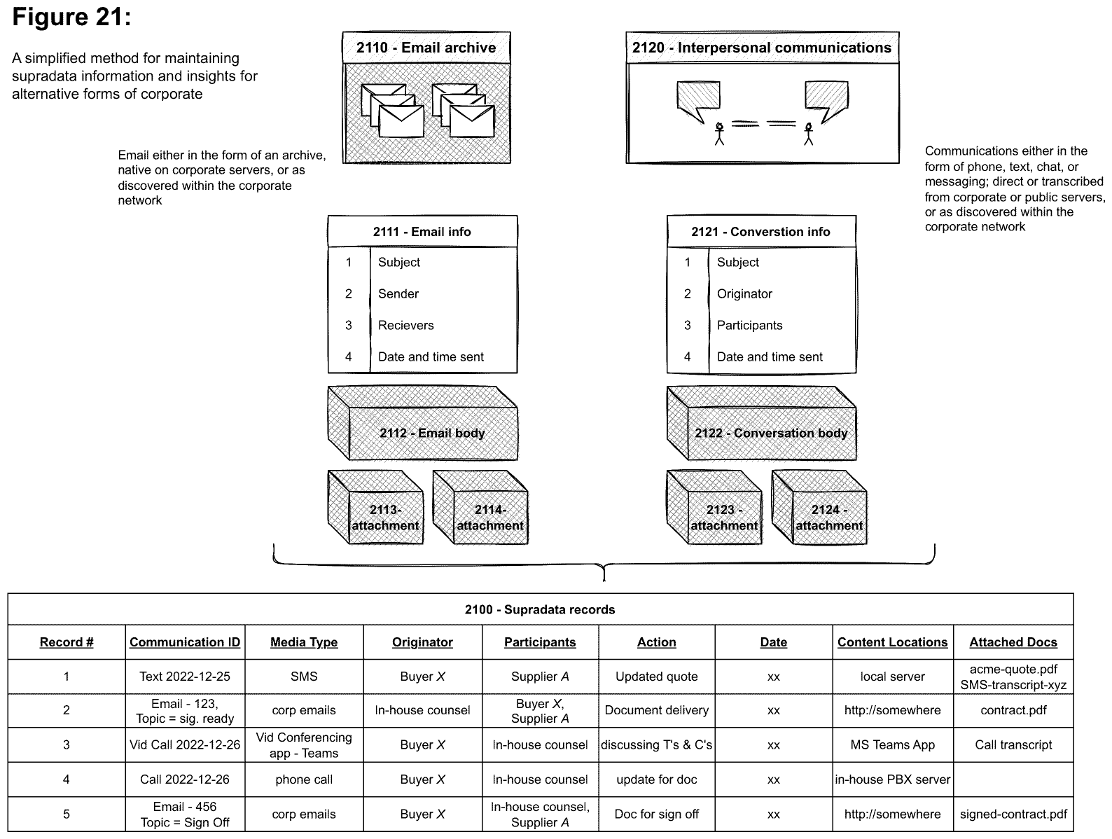

Referring to FIG. 21, illustrating this embodiment, shown is a method for storing and maintaining supradata for insights and information on alternative means of corporate communications. At supradata repository 2100, supradata records are maintained reflecting the information gleaned from real-world corporate communications, including emails at 2110 and alternative media at 2120. Alternative media are any communications to which the corporation or the monitoring service have access, including but not limited to texts, messaging, phone and cellular conversations or voicemails, VoIP (voice over IP) conversations or voicemails, chat and messaging applications, and video chatting or conferencing. Whether they are captured in their native media, i.e., voice, video, data, or they are transcribed, all of these forms of communication have useful information, which warrants capturing, tracking, and analyzing for actionable corporate insights.

For example, in FIG. 21, at 2111 and 2121 it can be seen that while both emails and alternative media are all forms of unstructured data, with a high degree of variety in their format and content, they do each contain data elements which may yield valuable and actionable insights. At some levels they may contain data elements which have a similar level of abstraction and parallel interpretation for inclusion and contextualization in the supradata records. Such parallels can be seen in the comparisons of 2111 Email Info to 2121 Conversation info, 2112 Email body to 2122 Conversation body, and 2113 and 2114 attachments to 2123 and 2124 attachments.

Because email messages are used in a lot of corporate communication, it is possible to analyse email messages in many contexts to extract significant information for use in evaluation, planning, verifying, communicating, training, improving processes, etc. It is also useful in email message management processes since email messages need not be preserved so long as the essential contextual information is within a supradata dataset. For example, once I know that for the last 5 years a customer was contacted between January 7^{th} and 9^{th}, I do not need the 5 emails reaching out and instead can store one exemplary proposed email and the supradata relating to the messages and their communication thread mappings. This allows for incorporation of email retention policies while maintaining information for future execution.

Without limitation, alternative forms of corporate communications are also prevalent in this era of social media and digital transformation. In the examples outlined, corporate communications focus on email. The supradata principles and capabilities are equally applicable to other forms of electronic communication including, but not limited to, SMS (simple messaging system aka texting), secure or private messaging systems such as offered by Slack® or Microsoft Teams® chat, even transcribed voicemails or live conversations over traditional phone lines, IP data lines and virtual channels or video conferencing applications and services. In each of these instances, organizational resources are being used for internal or external communications. With appropriate controls for governance and privacy, the organization is well within their moral bounds and legal rights to monitor these communications and glean insights from within. By applying supradata to the unstructured data, transcripts, listings, records, etc., offered by these alternative sources of corporate communications, no information gets lost in the shuffle. Supradata offers a cross-domain, cross-sources means of unifying and managing this source data and the information it contains to the benefit of the organization.

By example, consider a phone call between a buyer and a supplier. The buyer indicates a desire to buy a quantity of product, but the supplier is unsure if they can deliver from existing inventory. The supplier indicates they will get back to the buyer once they have had a chance to check their inventory. Both buyer and supplier in this instance are on the road so email is not a convenient communications medium. Upon checking the inventory, the supplier replies via SMS text the amount of inventory they can deliver by the buyer's target date. The buyer replies back with their agreement on the deal. Eventually, when they get back to their respective offices, the buyer and supplier both update their financial and ordering systems (with or without errors in the updates). It would be advantageous, to have the supradata which could track and find the actual initial raw communications across the three media, phone, text, and email, potentially correlated by time, topic, and participants, which precipitated the deal and then allow for cross-correlation with the updated financials. The consistent context supradata makes available across these multiple mediums of communications offers considerably greater insight than the traditional metadata, e.g., the time and date stamp on the recording of the original conversation. Further, analysis of the communications to form the supradata also allows for analysis of supradata for consistency providing each of the parties to the purchase to be informed of inconsistencies, potentially avoiding human error in data entry. For example, when entering data into the ordering system, a bubble might appear stating that the order quantity extracted from text messages was different from that entered; this allows the buyer and supplier to check their respective communications for correct values, when indicated.

In a further embodiment based on this example, supradata can be the underlying data repository and infrastructure upon which an automated solution would depend ensuring efficiency and accuracy of data management. In the example, the communications between the buyer and seller, as captured in supradata, act as the automation trigger and data source. When agreement is captured and acknowledged in their communications, automation kicks in generating the appropriate updates to their ERP and sales systems. Rather than manually entering the results of their exchange, with a potentially significant delay while they are on the road, the resulting orders are preloaded. Then the only requirement on the individuals is to either approve the entries or where their systems have developed sufficient trust, allow the automation to proceed without approval.

In some embodiments, the metadata is segmented metadata for each segment supporting a different function or system. In other embodiments the metadata for each system and function is different metadata collected and stored by different processes. In some embodiments, the metadata is linked to other metadata or within itself. In yet other embodiments, the metadata is linked to form a web of metadata that is traversable for analysis thereof.

Numerous other embodiments may be envisaged without departing from the scope of the invention.

What is claimed is:

1. A method comprising:
providing a data store comprising first data elements therein;
providing a first processing system having access to the data store;
providing a first metadata store comprising first metadata elements therein relating to the first data elements;
providing second metadata comprising additional metadata for use in generating one or more predictive models, the second metadata including data derived from at least some of the first metadata and the first data elements;
generating a predictive model based on at least the second metadata.

2. A method according to claim 1 wherein generating the predictive model is performed absent access to the first data elements.

3. A method according to claim 1 wherein the additional metadata includes metadata relating to data stored outside the datastore.

4. A method according to claim 3 wherein the additional metadata includes metadata relating to data stored on another computer system.

5. A method according to claim 4 wherein the another computer system is a computer system to which the first processing system does not have read access.

6. A method according to claim 5 wherein the another system provides metadata updates at intervals, the metadata updates for updating the second metadata.

7. A method according to claim 6 wherein the predictive model is based at least in part on data within the metadata updates.

8. A method according to claim 6 wherein the metadata updates comprise data derived from data on the another system and data derived from metadata on the another system, the metadata updates reflective of trend data for the data stored on the another system.

9. A method according to claim 6 wherein yet another system provides other metadata updates at intervals, the other metadata updates for updating the second metadata.

10. A method according to claim 9 wherein the other metadata updates comprise data derived from data on the yet another system and data derived from metadata on the yet another system, the other metadata updates reflective of trend data for the data stored on the yet another system.

11. A method according to claim 10 wherein different trend data is used to predict future events.

12. A method according to claim 11 wherein the second metadata includes context data for supporting predictive models within different contexts.

13. A method according to claim 12 wherein different contexts comprise at least one of temporal, geographic and event-based context.

14. A method according to claim 12 wherein different contexts comprise at least one of demographic and financial context.

15. A system comprising:
a plurality of security interfaces each defining a boundary for indicating a security of data within said boundary;
a plurality of data stores, each within the boundary of a different security interface of the plurality of security interfaces and each comprising data elements and metadata relating to the data elements stored therein; and
a plurality of processors each provided within the boundary of a different security interface, each processor having a metadata updating process for execution thereon and responsive to the security of data within said boundary, said metadata update process for being executed and for providing a metadata update at the security interface, the metadata update including metadata other than violating the security of data based on the security of data and a data access privilege of a system to which the metadata update is provided.

16. A system according to claim 15 wherein the metadata update process processes data elements and metadata elements accessible thereto and determines metadata updates from available data and particular to the security of data being provided via the security interface.

17. A system according to claim 15 wherein the metadata update process is a recursive process, each level of recursion receiving available metadata updates from lower levels of recursion prior to execution thereof.

18. A system according to claim 15 wherein the metadata update process is a recursive process.

19. A system according to claim 15 wherein each metadata update is incorporated into a local second metadata store and wherein different local second metadata update stores comprise different second metadata in dependence upon security interfaces therebetween.

20. A system according to claim 15 wherein each metadata update is incorporated into a local second metadata store and wherein different local second metadata update stores comprise different second metadata in dependence upon predictive modeling requirements thereof.
